(19) United States
(12) Patent Application Publication
(10) Pub. No.: US 2014/0098525 A1
(43) Pub. Date: Apr. 10, 2014

(54) Incremental Portable Power Station System

(71) Applicant: Aervoe Industries, Gardnerville, NV (US)

(72) Inventor: Michael Joseph Bennett, Zephyr Cove, NV (US)

(73) Assignee: Aervoe Industries, Gardnerville, NV (US)

(21) Appl. No.: 14/050,319

(22) Filed: Oct. 9, 2013

Related U.S. Application Data
(60) Provisional application No. 61/711,870, filed on Oct. 10, 2012.

(51) Int. Cl. H02J 7/00

(52) U.S. Cl. CPC H02J 7/0052
USPC 362/183; 320/135; 320/128; 320/136; 320/107

(57) ABSTRACT

An incremental portable power station system for providing power when no permanent power source is available. The system includes a set of removable, rechargeable batteries that are easily installed and removed. The system is configured to provide incremental power in stages, such as for example in 500 watt increments from 500 watts to 1,000 watts to 1,500 watts, etc. with one, two, three or more batteries installed. Power is provided to one or more outlets that may be standard 120 volt AC outlets, standard 12 volt car outlets, standard 5 volt USB outlets or any other outlet types. A charging station is also included for charging the batteries.

### RELATED CASE INFORMATION

This case claims priority benefit from U.S. Provisional Application No. 61/711,870, filed Oct. 10, 2012 entitled Incremental Portable Power Station System, which is incorporated herein by reference in its entirety.

### BACKGROUND

Portable power and battery recharging stations are generally available for use by police, fire, airport workers, construction crews, emergency personnel and consumers to provide a source of power when the user is outside the range for plugging into a standard AC outlet. These devices are especially useful for outdoor recreation, emergency preparedness, off grid power uses and construction where gas powered generators may have been the only available power source to date. Two major types of such stations are powered by solar or wind power storage.

Typical portable power stations currently on the market consist of some type of rechargeable battery, a power inverter, and various types of power outputs and several options that are used to recharge the internal battery. A block diagram of a sample prior art portable power supply is shown in FIG. 1. A prior art power supply (or portable power station) 100 includes a battery 105 with a standard voltage and amp hour capacity rating. Battery 105 is connected to a power inverter 110 which converts a low voltage to a high voltage, such as for example, 12 volts DC in to 120 volts AC out. Low voltage regulator 115 delivers either 12 volts or 5 volts via industry standard connectors from power inverter 110 to outputs 120 while a battery status display 125 shows the status of battery 105. Outputs 120 may provide an array of various output connections at different output voltages.

Portable power systems are typically rated in watt hours. For example a 12 volt 20 amp hour battery would provide a 240 watt hour power center. A 12 volt 10 amp hour battery would produce a 120 watt hour power center. The batteries are typically charged while they are in the power station enclosure. Almost all current product offerings use this simple single battery design. Due to many advances in battery chemistry technologies and consumer driven markets, the size and weight of certain battery chemistries have decreased while the capacities have increased. It is likely that this trend will continue enabling deployment of more powerful portable power stations without increasing the size in the future.

A problem with the current power stations on the market is that when the battery runs down, it must be recharged. Recharging requires an AC power source thereby limiting the time period during which a portable power station 100 of the type shown in FIG. 1 is useful. The present invention provides incremental stages of power as required by the user as well as an off-line auxiliary charging system that is a separate unit and is external to the main power center housing. The invention departs from the typical simplistic approach described above as it utilizes an incremental power system technology adding capacity as needed as well as routinely and easily swapping out rechargeable batteries when they are discharged.

### BRIEF DESCRIPTION OF THE DRAWINGS

FIG. 1 is a prior art portable power center in block diagram form;

FIG. 2 shows a perspective view of an incremental portable power station of the present invention with a battery pack removed;

FIG. 3A is a front view of an incremental portable power station;

FIG. 3B is an LED bar graph on a power output panel of an incremental portable power station;

FIG. 3C is a rear view of an incremental portable power station;

FIG. 3D is a block diagram of a top cutaway view of the portable power station housing and a battery in place within the housing;

FIG. 3E is a block diagram of a back view and a side view respectively showing the connector on the battery engaging in the housing;

FIG. 3F is a detailed view of the multi-pin spring-loaded pin connector on the battery;

FIG. 3G is a detailed view of a multi-position receiver connector on the housing;

FIG. 4A is a perspective view of a battery charger with batteries for use with an incremental portable power station;

FIG. 4B is a rear view of a battery charger for use with an incremental portable power station;

FIG. 5A is a block diagram of the electronics for an incremental portable power station;

FIG. 5B is an alternative design of the electronics of FIG. 5A for an incremental portable power station; and

FIG. 5C is an example of a battery isolation system for use in an incremental portable power station.

### DETAILED DESCRIPTION

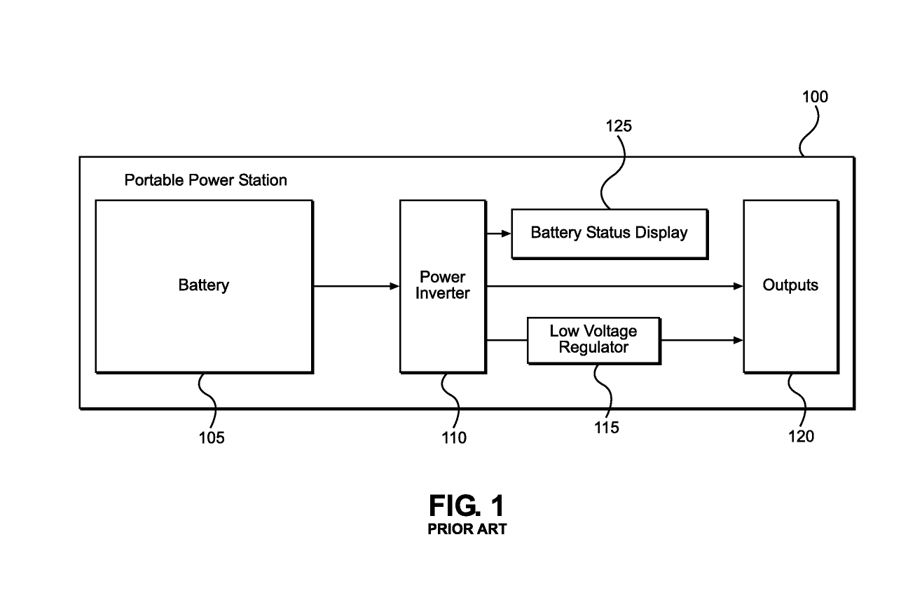

The present invention will now be described more fully with reference to the accompanying drawings. It should be understood that the invention may be embodied in many different forms and should not be construed as limited to the embodiments set forth herein. Throughout FIGS. 1-5, like elements of the invention are referred to by the same reference numerals for consistency purposes.

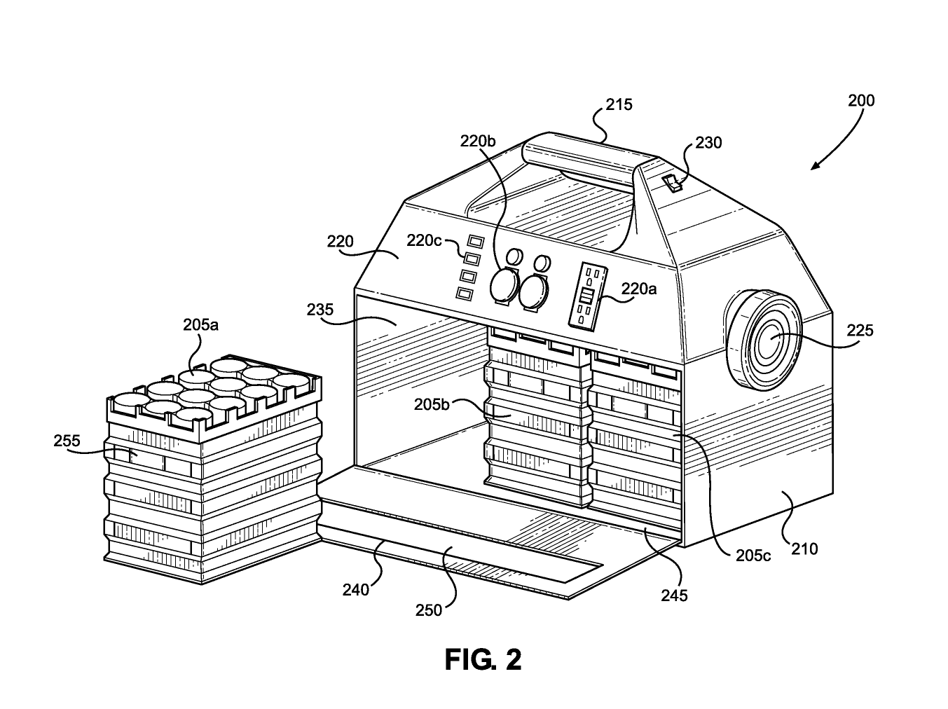

FIG. 2 an embodiment of an incremental portable power station 200 of the present invention. Power station 200 is powered by one or more battery packs 205 that are typically in the form of a lithium iron phosphate battery. It should be understood that other rechargeable battery types may also be used. In the representation of FIG. 2, power station 200 is shown with three battery packs 205. A first battery pack 205a is removed from power station 200 and two other battery packs 205b, 205c are installed in power station 200. Each battery pack 205, may be for example, rated at 12 volts and 40 amp hours. In this configuration, power station 200 would likely provide 500 watt hours with a single battery pack 205 in place, 1,000 watt hours with two battery packs in place and 1,500 watt hours with three battery packs in place. It should be understood that larger or smaller capacity battery packs may be used in the same size and format.

Power station 200 has an ergonomically designed housing 210 that provides space to plug in between one and three modular rechargeable batteries 205. It should be understood that housing 210 could be made larger to accommodate more battery packs or smaller to accommodate fewer battery packs. Further, housing 210 is shown with a lower portion generally in the shape of a box and an upper portion with sides that slope up to form an integrated handle 215 for use by a user to easily carry power station 200. It should be understood that housing 210 may take on any number of different shapes that are ergonomically suitable.

Along a designated area of housing 210 are provided a set of outputs 220 into which electrical appliances may be plugged in for use. Outputs 220 may be in different formats including two standard 120 volt AC outlets 220a (with or without GFI protection), two 12 volt vehicle plugs 220b typically delivering 15 amps, four USB port outlets 220c delivering 5 volts and 1,500 milliamps. The number and type of outlets may be different, and any other outlet types may be included. For example, a standard 220 volt European format or a standard 100 volt Japanese format may also be provided.

Power station 200 may also include an integrated light 225 for use as a flashlight. Light 225 may be a high powered LED or any other type of standard bulb. LEDs are preferable because they use less power. Light 225 is activated by an ON/OFF switch 230 positioned on housing 210 and is powered by battery packs 205.

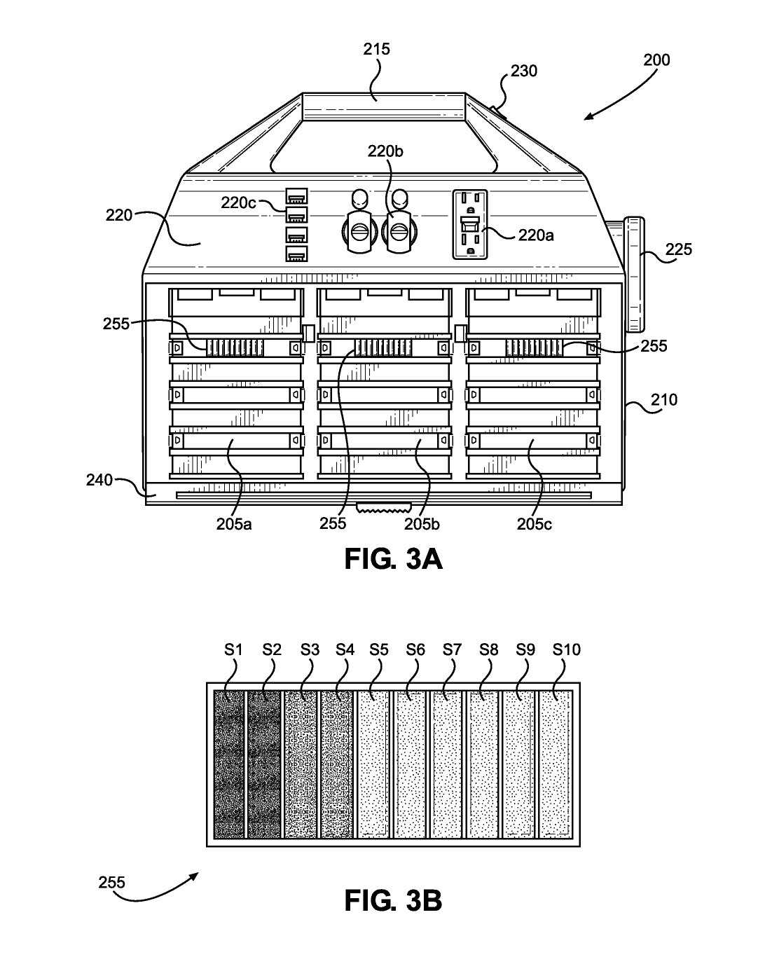

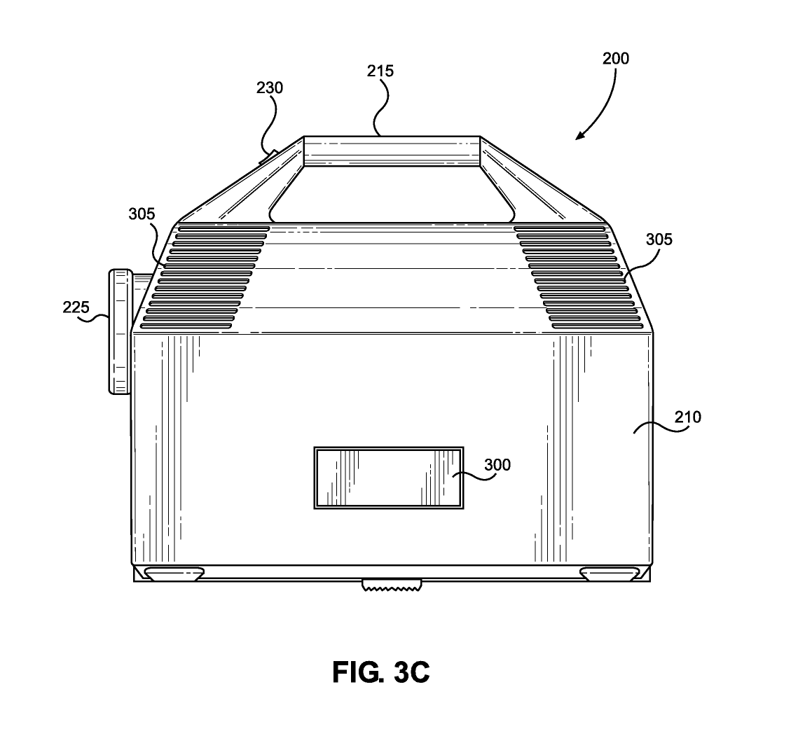

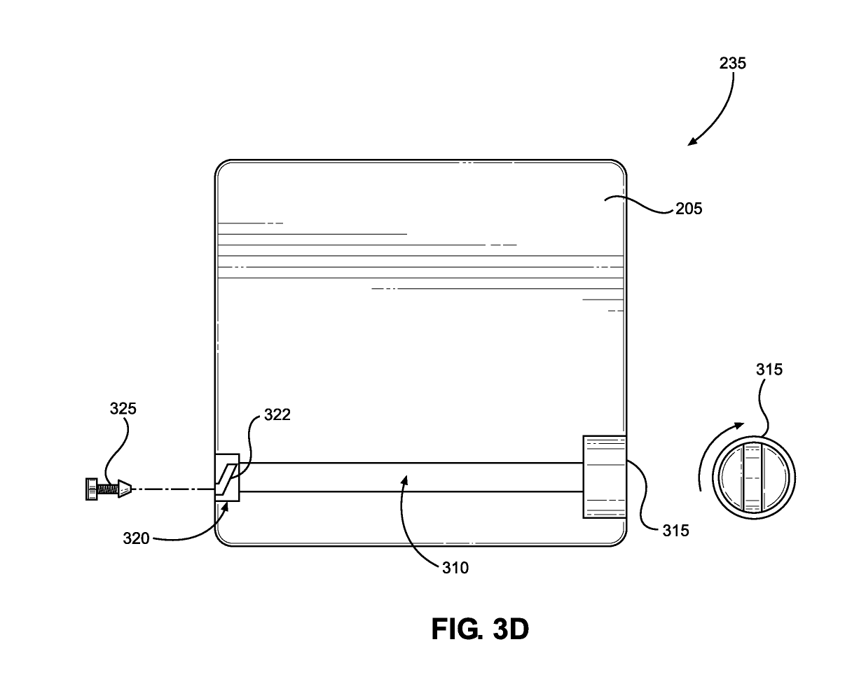

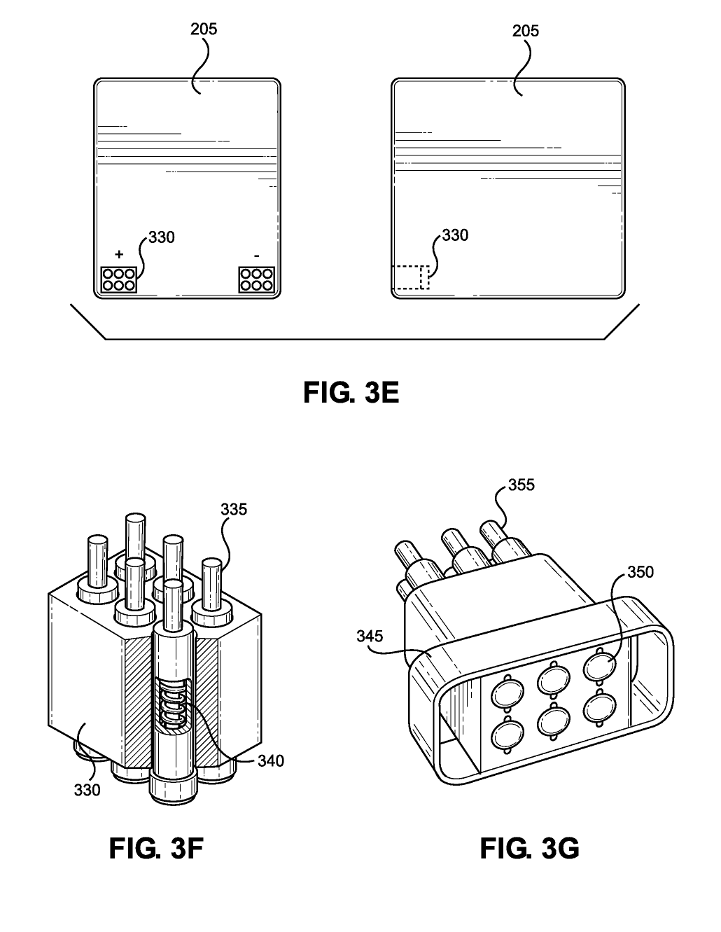

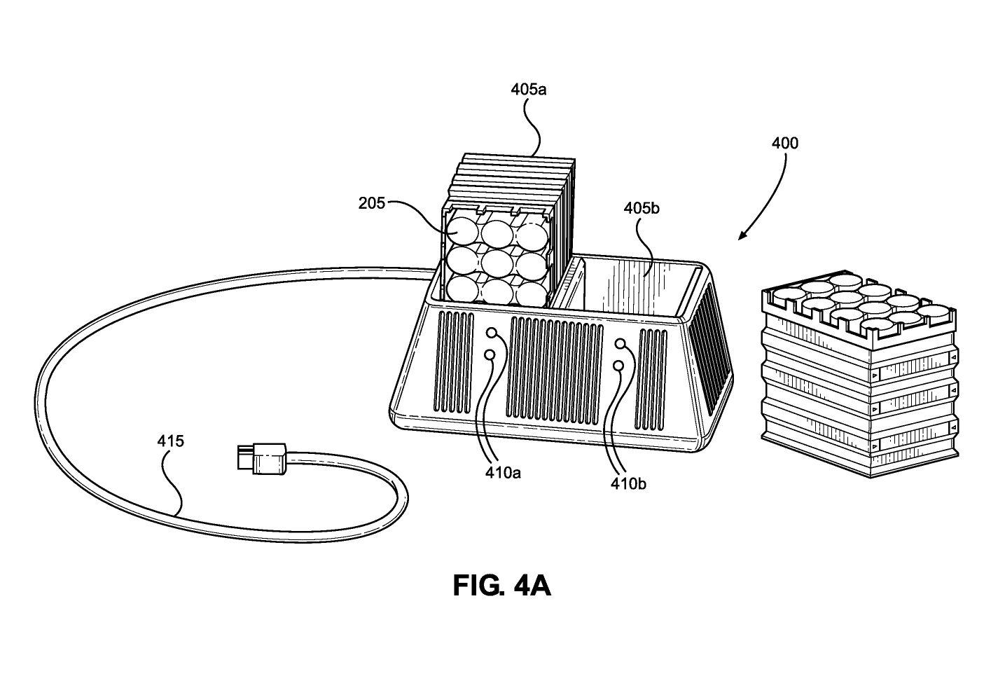

Battery packs 205 are installed in housing 210 in slidable slots 235 with each battery pack being accommodated in an individual slideable slot. As battery pack 205 is slid into slideable slot 235, a set of spring pin high current contacts (see FIGS. 3E-3F) on the backside of battery pack 205 engage a connector (see FIG. 3D) mounted on the back inside panel of housing 210. Slideable slots 235 may also include guides along the top and/or bottom panels on the inside of housing 210 to ensure that the contacts on battery pack 205 properly align and engage the connector on the inside back panel of housing 210. A simple locking action is achieved when battery pack 205 is seated in the connector. A battery panel door 240 that operates on a hinge 245 may then be closed. Door 245 includes a slot 250 through which a power gauge 255 positioned on the outer surface of each battery pack 205 is viewable. A window may be installed in slot 250 that is preferably made of plastic to minimize weight and protect battery packs 205 from dirt and other debris. Upon proper seating of battery packs 205 in housing 210, power station 200 is ready for operation.

Each battery pack 205 may be quickly and easily installed and removed from housing 210 through door 240. A user may purchase additional battery packs to carry with them in the event that the battery packs installed in power station 200 are used up. A user is always aware of the current status of battery charge by viewing power gauge 255 through slot 250 in door 245. When one or more battery packs run low or are exhausted, the user is able to quickly swap out a fully recharged battery pack.

When installed, each battery pack 205 is capable of powering station 200 irrespective of whether one or more other batteries are installed in the unit or whether the level of charge of any other installed battery is low or dead. This allows a user to rely on any battery 205 installed in any slot 235 without having to worry about installing a charged battery in any particular “primary” or “main” slot 235 to power station 200.

FIG. 3A is a front view of power station 200 with door 240 in the open position. Battery packs 205a-c are installed in housing 210 and a power gauge 255 is visible on each battery pack 205. Power gauge 255 is shown in bar graph form with ten vertical segments in greater detail in FIG. 3B. Viewing the bar graph from left to right, the two leftmost segments 51 and S2 are illuminated in red, the next two segments S3 and S4 are illuminated in yellow or orange and the six rightmost segments S5-S10 are illuminated in green. As the power in battery pack 205 is consumed and the power runs down, illumination of each individual segment is turned off from left to right to indicate to the user the level of power remaining in successive 10% amounts. It should be understood that other forms of a gauge may be used, for example, a round gauge with pie-shaped segments.

FIG. 3C is a rear view of power station 200. A panel door 300 may be opened to access a set of fuses that are used to protect outlets 220a-c in the event of a power surge. Also included in the rear panel of housing 210 are a set of slotted vents 305 to allow heat to escape from the inside of housing 210.

FIG. 3D is a top view of a battery slot 235 in power station 200 in which a battery pack 205 is inserted in slot 235. A shaft 310 extends through battery pack 205 with a knob 315 on the front of battery pack 205 that is accessible when battery pack 205 is inserted in slot 235. A separate front view of knob 315 is shown just to the right of the side view of knob 315 attached to shaft 310. When knob 315 is turned, it rotates cam 320 which locks a latch 322 onto lock pin 325 at the back of slot 235 and mounted through the rear of housing 210.

FIG. 3E is a block diagram of a back view and a side view respectively showing a pair of connectors 330 (positive and negative) on battery pack 205 for engaging mated connectors attached to the housing. Arrays of pins 335 are used to increase the current capacity and the reliability of contact pin connectors 330. They are typically available with current ratings of 2-25 amps. Since each battery 205 is typically 40 amps, each array would have to be capable of 40 amps with a peak current draw of 60 mps.

Each battery pack 205 has an appropriate number of contacts to handle the current. Each battery pack 205 has a contact array that matches up with a target or receiver array on the housing (see FIG. 3G). Contacts 335 are recessed into the housing of battery pack 205 so that they are not easily exposed where they may inadvertently contact external components and possibly short circuit. An example of a contact array 330 is shown in FIG. 3F. In FIG. 3F, a 6-pin contact array 330 is shown with a cutaway view of one of the contacts 335 and a spring 340. FIG. 3G is a detailed view of a multi-position receiver connector 345 that is mounted to the inside of housing 200. When battery pack 205 is moved into position inside housing 200, contacts 335 on connector 330 meet contacts 350 on connector 345 so that power from battery pack 205 is supplied to a circuit that is connected to the backside pins 355 on connector 345.

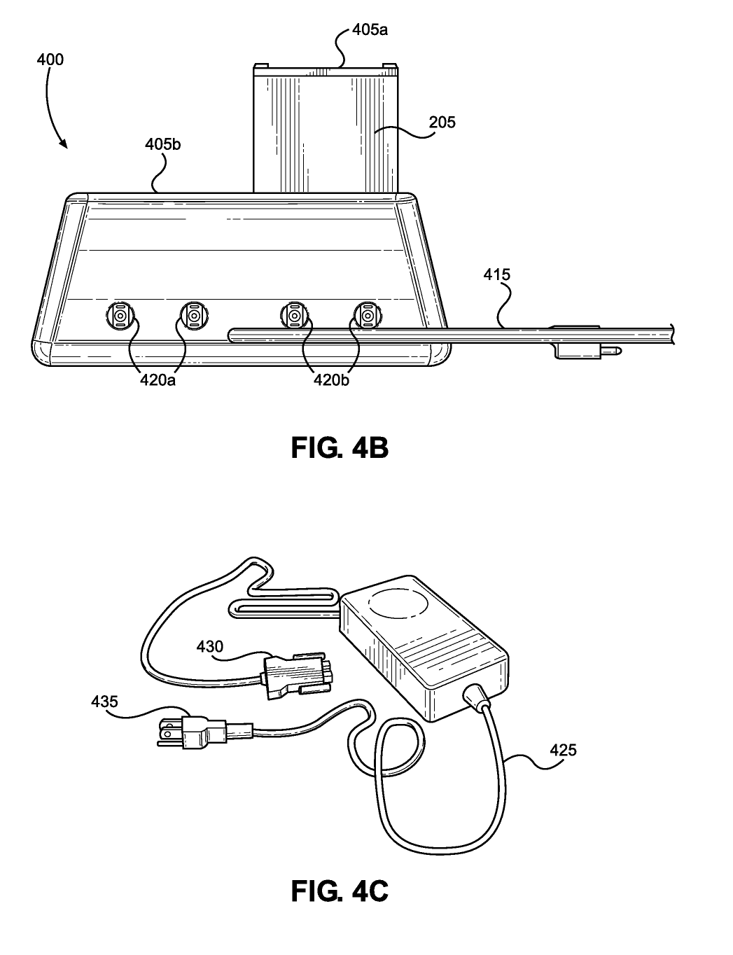

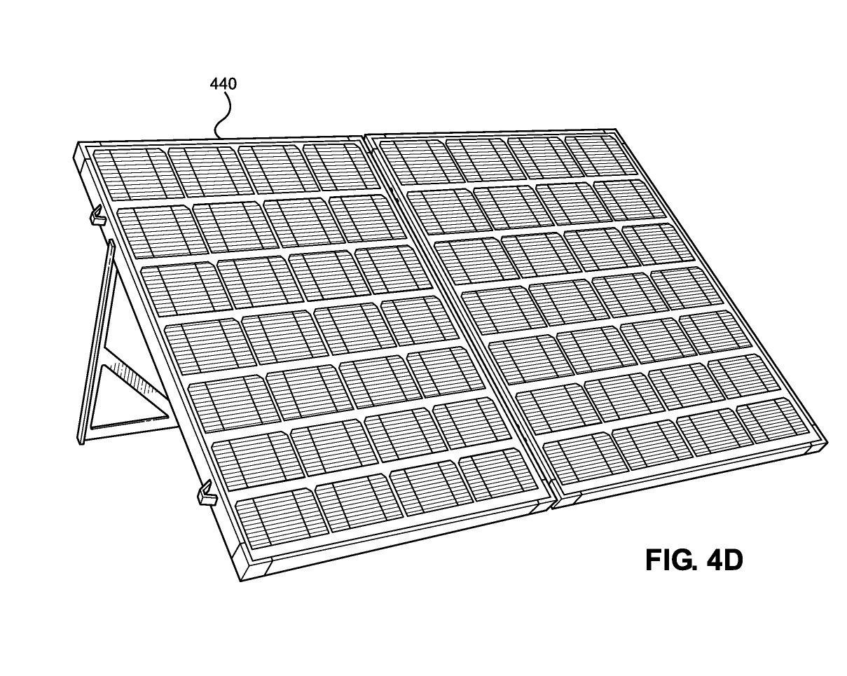

Power station 200 may be used in conjunction with a charging station 400 shown in FIGS. 4A-4B. Charging station 400 is preferably made of a durable plastic housing that includes two charging slots or bays 405, each of which accommodates a battery pack 205 for charging. It should be understood that the two bays 405 shown in FIG. 4A is an example and the actual number of bays may be any number that is 1 or more. A connector of the same type as used in housing 210 of power station 200 is positioned at the bottom of each bay 405 to accept the connector pins on battery pack 205. When a battery pack 205 is inserted in bay 405, power gauge 255 is visible to a user so that the user may monitor the charging cycle and immediately determine the level of power in battery pack 205 as it charges. As can be seen in FIG. 4A, bay 405a has a battery pack 205 in place for charging, while bay 405b is empty. Charging station 400 has a set of LED charge status indicators 410 corresponding to each bay 405. An upper LED for each slot may be red and indicate that charge is in progress while a lower LED for each slot may be green and indicate that the charge cycle is complete. A power cord 415 may include a standard AC plug that can be plugged into a standard 120 volt AC outlet or it may be another type of plug such as a DC plug of the type used in automobiles or a USB type plug. In any of these configurations, the charger station 400 is set up to deliver power for charging to a battery inserted in a bay 405 of charging station 400.

FIG. 4B is a rear view of charging station 400. In addition to being able to draw power from a standard 12 volt outlet, USB or automobile style plug, charging station 400 may alternatively use solar or wind power to charge battery packs 205. A pair of standard MC4 connectors 420a, 420b are provided for each charging slot 405. Each connector pair has a positive and negative connector that can accept 12-28 volts DC and up to 250 watts of energy. Alternatively, an AC charger cord 425 such as shown in FIG. 4C may be plugged directly into power station 200 at one end using a connector 430 while a standard AC plug 435 at the other end of cord 425 is plugged into an AC outlet. Station 200 may also include other connector types for charging such as those shown and described in FIG. 4B to accomplish charging using a solar panel 440 as shown in FIG. 4D, a wind turbine or any other type of power generator.

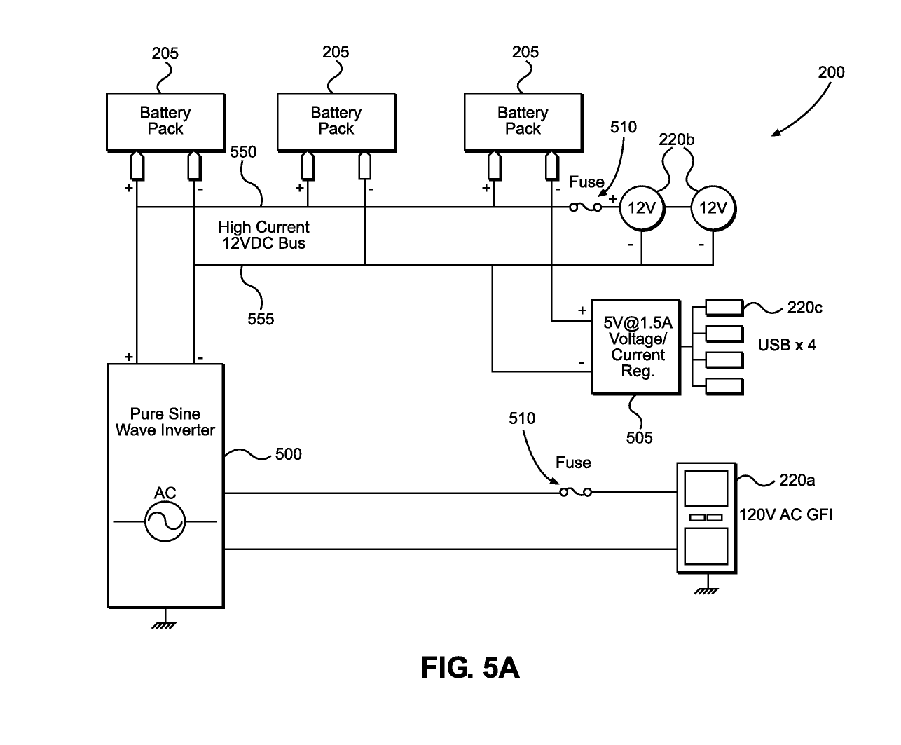

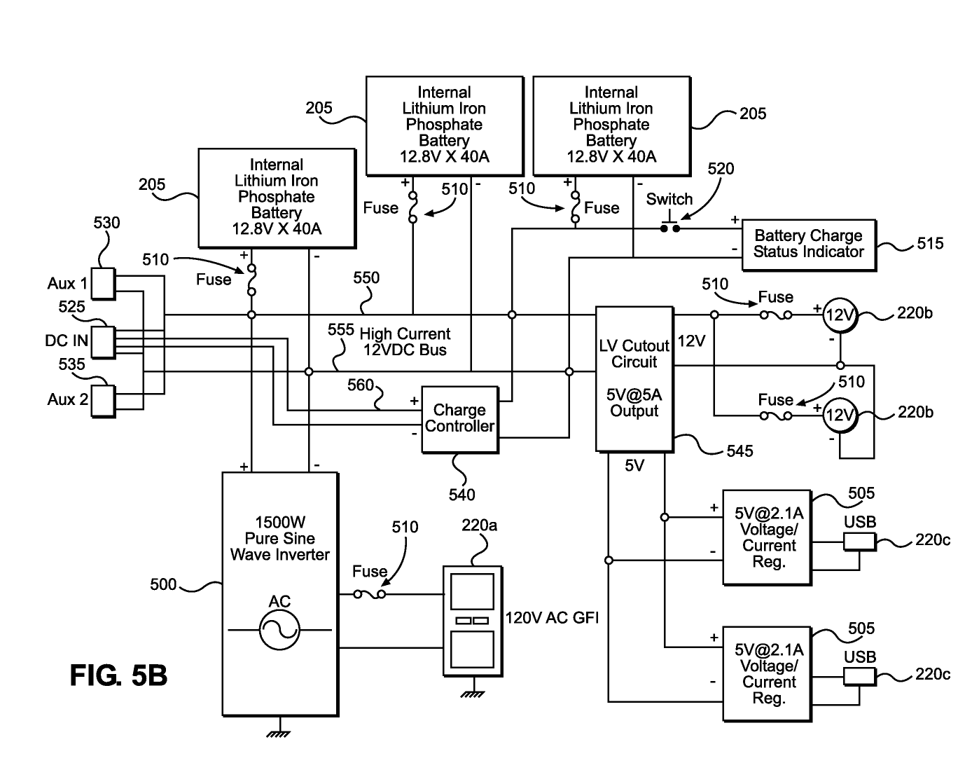

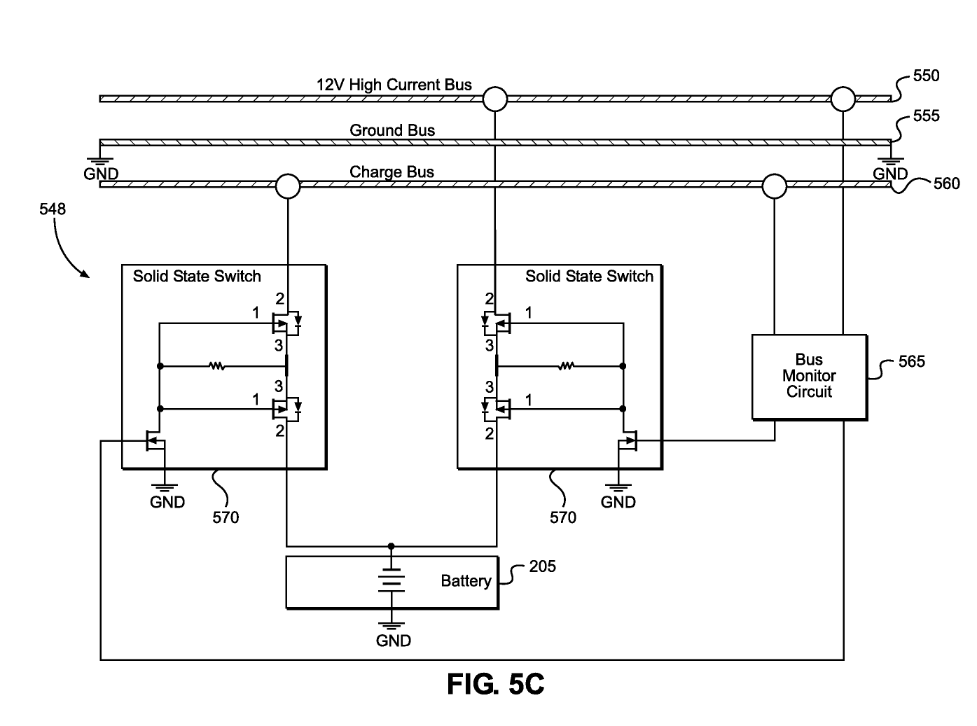

FIG. 5A is a block diagram of the electronics for an incremental portable power station 200. As can be seen from FIG. 5A, three battery packs 205 are installed in portable power station 200 to supply power. Battery packs 205 are installed in parallel such that any one of the battery packs can provide power to system 200 irrespective of whether another battery pack is installed or whether one or more installed battery pack is discharged or low. A power management system is needed to isolate battery packs 205 because batteries of different charge levels cannot simply be connected together. The isolation system may comprise high current Schottky diodes, or back-to-back MOSFET (metal oxide semiconductor field effect transistor) or HEXFET (hexagonally shaped field effect transistor) circuits that allow each of batteries 205 to be connected or disconnected from the 12 volt high current bus or the charge bus as required. The isolation system circuit is not shown in FIG. 5A for purposes of simplicity, but it is shown in a more detailed alternative circuit shown in FIG. 5C and described below.

It should be understood, that the power available from power station 200 may be incrementally scaled up or down in stages as required by adding or removing battery packs 200. The electronics of power station 200 include 12 volt outlets 220b connected directly to battery packs 205 for delivering 12 volts. For outlets 220a delivering 120 volts, a pure sine wave inverter 500 is connected serially between battery packs 205 and 12 volt outlets 220a to make the appropriate power conversion. Similarly, for outlets 220c delivering 5 volts, a 5 volt, 1,500 milliamp voltage current regulator 505 is connected serially between battery packs 205 and outlets 220c to make the appropriate power conversion. Fuses 510 are also serially connected between outlets 220b and battery packs 205, and also between outlets 220a and sine wave inverter 500 to protect any appliances plugged into outlets in the event of a power surge.

FIG. 5B is a block diagram of an alternative electronic circuit for an incremental portable power station 200. As can be seen from FIG. 5B, three battery packs 205 are installed in portable power station 200 to supply power. Battery packs 205 are installed in parallel such that any one of the battery packs can provide power to system 200 irrespective of whether another battery pack is installed or whether one or more installed battery pack is discharged or low. It should be understood, that the power available from power station 200 may be incrementally scaled up or down in stages as required by adding or removing battery packs 200. The electronics of power station 200 include 12 volt outlets 220b connected directly to battery packs 205 for delivering 12 volts. For outlets 220a delivering 120 volts, a pure sine wave inverter 500 is connected serially between battery packs 205 and 12 volt outlets 220a to make the appropriate power conversion. Similarly, for USB outlets 220c delivering 5 volts, a 5 volt, 1,500 milliamp voltage current regulator 505 is connected serially between battery packs 205 and outlets 220c to make the appropriate power conversion. Fuses 510 are also serially connected between outlets 220b and battery packs 205, and also between outlets 220a and sine wave inverter 500 to protect any appliances plugged into outlets in the event of a power surge.

A battery charge status indicator 515 with a switch 520 is used to show that one or more of batteries 205 are currently being charged when a power source is connected to station 200 to charge batteries 205. Switch 520 may be placed in an “on” position to enable charging and an in an “off” position to disable charging. Charging is effectuated by connecting a charging source to power station 200 which may be a number of different alternative sources such as a DC input like a solar panel 440 as shown in FIG. 4D or a wind turbine that is plugged into DC input 525. A charging source may also deliver AC power through Aux input 1 530 or Aux input 2 535 such as from an outlet into which station 200 is plugged using a cord 425 as shown in FIG. 4C. A charge controller 540 operates in conjunction with a high voltage cutoff and over current protection circuit 545 to ensure that battery packs 205 and the station 200 are protected from outside power sources during charging operations.

A battery isolation system is shown as circuit 548 of FIG. 5C. Battery isolation system 548 is used with either of the circuit embodiments shown in FIG. 5A and FIG. 5B, and is positioned between each battery 205 and the high current bus 550, ground 555 and charge bus 560. A bus monitor circuit 565 continuously checks the status of the buses to determine whether or not a battery 205 can safely connect to high current bus 550 and share the load. This is accomplished through switches 570 which may be, for example, solid state switches including back-to-back P-channel MOSFETs with the appropriate current and voltage rating as will be recognized and understood by those of skill in the art. Switches 570 are configured to selectively switch battery 205 to be connected between charge bus 565 and high current 12V bus 550 by bus monitor circuit 565 when appropriate.

In operation, circuit 548 ensures that battery 205 is switched to provide power to 12 volt high current bus 550 when the same voltage or a higher voltage is provided by one or more of the other batteries 205. The higher voltage state can include 0 volts on high current bus 550, which occurs when no other battery is connected to bus 550. If the voltage of a particular battery 205 is lower than that being provided to the high current bus 550 within a predetermined tolerance window, battery monitor circuit 565 will switch that battery to charge bus 560 and permit charging when a source of charging is available. If the battery reaches a threshold depth of charge or its predetermined cutoff voltage, such as for example 80%, that battery is switched to charge bus 560 even if charge voltage is not present on charge bus 560 thereby disconnecting that battery from high current bus 550 and preventing further discharge. That battery will not be reconnected until it is recharged and its charge level is equal to or above the level of any other battery connected to high current bus 550.

The foregoing invention has been described in accordance with the relevant legal standards, thus the description is exemplary rather than limiting in nature. Variations and modifications to the disclosed embodiment may become apparent to those skilled in the art and fall within the scope of the invention. For example, the number or placement of particular outlets such as USB, AC or automobile outlets on station 200 as shown in the figures is intended to be a representation of a particular embodiment without being a design constraint. Further, the types of connectors 330, 345 and the pin configurations used on battery packs 205 and inside housing 200 are a design choice. The types of solid state switches 570 used in isolation circuit 548 are also subject to designer discretion. The implementations shown herein are representative of a particular configuration that may be altered depending on the use. Accordingly the scope of legal protection afforded this invention can only be determined with reference to the claims.

What is claimed is:

1. An portable power station comprising:
a housing with an interior area having at least two connectors for receiving at least two removable, rechargeable batteries;
at least two removable, rechargeable batteries shaped to fit inside of the interior area of the housing wherein each battery has a set of contacts for connecting to one of the at least one connector;
at least one outlet on the housing powered by the at least two batteries wherein at least one of the at least two batteries has a charge remaining and is installed in the housing;
a circuit in the housing that is in electrical connection between the at least two connectors and the at least one outlet to deliver power from at least one of the at least two batteries to the at least one outlet; and
wherein each additional battery installed provides incremental stages of power at the at least one outlet.

2. The apparatus of claim 1 wherein the at least one outlet includes outlet types from the group comprising: 1) standard American 12 volt DC plug; 2) standard 120 volt AC plug; 3) standard 5 volt USB port; and 4) standard European 220 volt AC plug; or 5) standard Japanese 100 volt plug.

3. The apparatus of claim 1 wherein each of the at least two batteries further comprise a power gauge to indicate the amount of power remaining on the battery.

4. The apparatus of claim 1 further comprising a charging source that is one of the group comprising: (a) an external power station including at least one charging slot for charging a battery; and (b) a charger circuit in the portable power station connected between an external power source and the at least two batteries.

5. The apparatus of claim 4 wherein the charging source further comprises at least one indicator to indicate that either: 1) a charge is complete; or 2) a charge is in progress.

6. The apparatus of claim 4 wherein the power source is from the group comprising: 1) an alternating current source using a standard AC plug; and 2) an alternative power source using a standard MC4 power connector.

7. The apparatus of claim 1 wherein the housing further comprises a first lock mechanism and the battery pack further comprises a second lock mechanism wherein the first lock mechanism engages the second lock mechanism when the battery is fully inserted in the housing.

8. The apparatus of claim 1 wherein the contacts on the battery are spring loaded high powered contacts.

9. The apparatus of claim 8 further comprising a knob wherein the knob is turned in a first direction to engage the second lock mechanism with the first lock mechanism and turned in a second direction to disengage the second lock mechanism from the first lock mechanism.

10. The apparatus of claim 2 further comprising a flashlight wherein the flashlight is connected to and powered by the batteries.

11. The apparatus of claim 1 further comprising:
a first isolation circuit in electrical connection between each battery and a high current bus;
a second isolation circuit in electrical connection between each battery and a charge bus; and
a bus monitor circuit in electrical connection between each of the first and second isolation circuits and each of the high current and charge buses, wherein the bus monitor circuit monitors voltage levels on the high current bus and the charge bus and switches a connection between a first state and a second state such that the battery is connected to the high current bus in a first state and the charge bus in a second state.

12. A method of supplying power using a portable power station comprising:
providing a housing with an interior area having at least two connectors for receiving at least two removable, rechargeable batteries;
inserting at least two removable, rechargeable batteries into the housing in an interior area of the housing wherein each battery has a set of contacts for connecting to one of the at least one connector;
supplying power to at least one outlet on the housing from at least two batteries wherein at least one of the at least two batteries has a charge remaining and is installed in the housing;
providing a circuit in the housing that is in electrical connection between the at least two connectors and the at least one outlet to deliver power from at least one of the at least two batteries to the at least one outlet; and
wherein each additional battery installed provides incremental stages of power at the at least one outlet.

13. The method of claim 12 wherein the at least one outlet includes outlet types from the group comprising: 1) standard American 12 volt DC plug; 2) standard 120 volt AC plug; 3) standard 5 volt USB port; and 4) standard European 220 volt AC plug; or 5) standard Japanese 100 volt plug.

14. The method of claim 12 wherein each of the at least two batteries further comprise a power gauge to indicate the amount of power remaining on the battery.

15. The method of claim 12 further comprising a charging source that is one of the group comprising: (a) an external power station including at least one charging slot for charging a battery; and (b) a charger circuit in the portable power station connected between an external power source and the at least two batteries.

16. The method of claim 15 wherein the charging source further comprises at least one indicator to indicate that either: 1) a charge is complete; or 2) a charge is in progress.

17. The method of claim 15 wherein the power source is from the group comprising: 1) an alternating current source using a standard AC plug; and 2) an alternative power source using a standard MC4 power connector.

18. The method of claim 12 wherein the housing further comprises a first lock mechanism and the battery pack further comprises a second lock mechanism wherein the first lock mechanism engages the second lock mechanism when the battery is fully inserted in the housing.

19. The method of claim 12 wherein the contacts on the battery are spring loaded high powered contacts.

20. The method of claim 19 further comprising a knob wherein the knob is turned in a first direction to engage the second lock mechanism with the first lock mechanism and turned in a second direction to disengage the second lock mechanism from the first lock mechanism.

21. The method of claim 12 wherein the housing further comprising a flashlight wherein the flashlight is connected to and powered by the batteries.

22. The method of claim 12 wherein the circuit further comprises:
a first isolation circuit in electrical connection between each battery and a high current bus;
a second isolation circuit in electrical connection between each battery and a charge bus; and
a bus monitor circuit in electrical connection between each of the first and second isolation circuits and each of the high current and charge buses, wherein the bus monitor circuit monitors voltage levels on the high current bus and the charge bus and switches a connection between a first state and a second state such that the battery is connected to the high current bus in a first state and the charge bus in a second state.
